(19) United States
(12) Patent Application Publication
(10) Pub. No.: US 2025/0314518 A1
(43) Pub. Date: Oct. 9, 2025

(54) SENSOR

(71) Applicant: LG ELECTRONICS INC., Seoul (KR)

(72) Inventors: Mangeun KIM, Seoul (KR); Sunghyun YI, Seoul (KR); Hyunjin PARK, Seoul (KR)

(73) Assignee: LG ELECTRONICS INC., Seoul (KR)

(21) Appl. No.: 19/098,853

(22) Filed: Apr. 2, 2025

(30) Foreign Application Priority Data
Apr. 3, 2024 (KR) 10-2024-0045162
Jul. 19, 2024 (WO) PCT/KR2024/010410

(51) Int. Cl. G01F 23/263

(52) U.S. Cl. CPC G01F 23/268; G01F 23/266

(57) ABSTRACT

The present disclosure relates to a sensor. The sensor of the present disclosure includes a plurality of vertical electrodes which are extended vertically and arranged to face each other; a first horizontal electrode arranged on a lower side of the plurality of vertical electrodes; and a shield electrode arranged on the lower side of the plurality of vertical electrodes so as to cover the first horizontal electrode from an upper side, in which the first horizontal electrode and the shield electrode are arranged to be immersed in a fluid that at least contains oil, a sensing voltage is applied to a first vertical electrode and the first horizontal electrode, and a ground voltage is applied to a second vertical electrode and the shield electrode.

### CROSS-REFERENCE TO RELATED APPLICATION

Pursuant to 35 U.S.C. § 119, this application claims the benefit of earlier filing date and right of priority to Korean Application No. 10-2024-0045162, filed on Apr. 3, 2024, and International Application No. PCT/KR2024/010410, filed on Jul. 19, 2024, the contents of which are all incorporated by reference herein in their entirety.

### TECHNICAL FIELD

This disclosure relates to a sensor, and more particularly, to a sensor for calculating the amount of oil existing inside a compressor.

### BACKGROUND

A compressor is installed in a home appliance such as a refrigerator and an air conditioner or in a vehicle to compress refrigerant. The compressor is connected to a condenser and an evaporator, and can compress a refrigerant evaporated from the evaporator and supply it to the condenser.

In order to protect the compressor from mechanical friction, lubrication or cooling is performed through oil, and the compressor must always have a certain level of oil or more. The oil inside the compressor circulates through a refrigerant cycle together with the refrigerant discharged from the compressor. At this time, if the oil accumulates in the condenser, evaporator, and pipe of the refrigerant cycle, it will cause a decrease in the system's capacity, and if the oil recovery is not smooth, the amount of oil inside the compressor will be insufficient, which may cause damage to the compressor. In order to prevent such damage to the compressor, the system performs an oil recovery operation to recover the oil accumulated in the condenser, evaporator, and pipe to the compressor.

In the conventional case, a separate oil level sensor is arranged in the compressor, and oil recovery operation is performed according to the amount of oil detected by the oil level sensor. If an oil level sensor is used, unnecessary oil recovery operation can be reduced, thereby increasing energy efficiency and reliability of compressor performance.

However, according to a conventional method, the oil level sensor is arranged at a certain location inside the compressor, so that it is only possible to check whether the amount of oil existing inside the compressor corresponds to the certain location where the oil level sensor is installed. Thus, there is a problem that a plurality of oil level sensors must be installed at various locations inside the compressor in order to accurately detect the amount of oil existing inside the compressor.

### SUMMARY

The disclosure has been made in view of the above problems, and may provide a sensor capable of accurately detecting the concentration of oil existing inside a compressor.

The disclosure may further provide a sensor capable of accurately detecting the amount of oil based on the concentration of oil existing inside a compressor.

In accordance with an aspect of the present disclosure, a sensor includes a plurality of vertical electrodes which are extended vertically and arranged to face each other; a first horizontal electrode arranged on a lower side of the plurality of vertical electrodes; and a shield electrode arranged on the lower side of the plurality of vertical electrodes so as to cover the first horizontal electrode from an upper side, in which the first horizontal electrode and the shield electrode are arranged to be immersed in a fluid that at least contains oil, a sensing voltage is applied to a first vertical electrode and the first horizontal electrode, and a ground voltage is applied to a second vertical electrode and the shield electrode.

In accordance with another aspect of the present disclosure, a sensor includes a plurality of vertical electrodes which are extended vertically and arranged to face each other; a first horizontal electrode arranged on a lower side of the plurality of vertical electrodes; a ground electrode arranged on a lower side of the plurality of vertical electrodes; and a shield electrode arranged on the lower side of the plurality of vertical electrodes so as to cover the first horizontal electrode and the ground electrode from an upper side, in which the shield electrode, the first horizontal electrode, and the ground electrode are arranged to be immersed in a fluid that at least contains oil, a sensing voltage is applied to a first vertical electrode and the first horizontal electrode, and a ground voltage is applied to a second vertical electrode and the ground electrode.

### BRIEF DESCRIPTION OF THE DRAWINGS

The above and other objects, features and advantages of the present disclosure will be more apparent from the following detailed description in conjunction with the accompanying drawings, in which:

FIG. 1A and FIG. 1B are diagrams illustrating a configuration of a system, according to an embodiment of the present disclosure;

FIG. 2 is a block diagram of a system, according to an embodiment of the present disclosure;

FIG. 3 is a block diagram of a sensor, according to an embodiment of the present disclosure;

FIG. 4 is a diagram illustrating a configuration of an electrode assembly, according to an embodiment of the present disclosure;

FIG. 5 and FIG. 6 are diagrams for explaining a sensor, according to an embodiment of the present disclosure;

FIG. 7 is a diagram illustrating a configuration of an electrode assembly, according to another embodiment of the present disclosure; and

FIG. 8 and FIG. 9 are diagrams for explaining a sensor, according to another embodiment of the present disclosure.

### DETAILED DESCRIPTION

Hereinafter, the present disclosure will be described in detail with reference to the drawings. In the drawings, in order to clearly and concisely describe the present disclosure, parts that are not related to the description are omitted, and the same drawing reference numerals are used for identical or extremely similar parts throughout the specification.

The suffixes “module” and “part” used for components in the following description are given simply for the convenience of writing this specification, and do not in themselves impart any particularly important meaning or role. Therefore, the above “module” and “part” may be used interchangeably.

In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof.

In addition, in this specification, terms such as first, second, etc. may be used to describe various elements, but these elements are not limited by these terms. These terms are used only to distinguish one element from another.

Hereinafter, direction is defined based on a rectangular coordinate system. In the rectangular coordinate system, the x-axis direction may be defined as a left-right direction. At this time, based on the origin, the direction toward +x may mean a right direction, and the direction toward −x may mean a left direction. In addition, the y-axis direction may be defined as a front-rear direction. At this time, based on the origin, the direction toward +y may mean a forward direction, and the direction toward −y may mean a rearward direction. In addition, the z-axis direction may be defined as an up-down direction. At this time, based on the origin, the direction toward +z may mean an upward direction, and the direction toward −z may mean a downward direction.

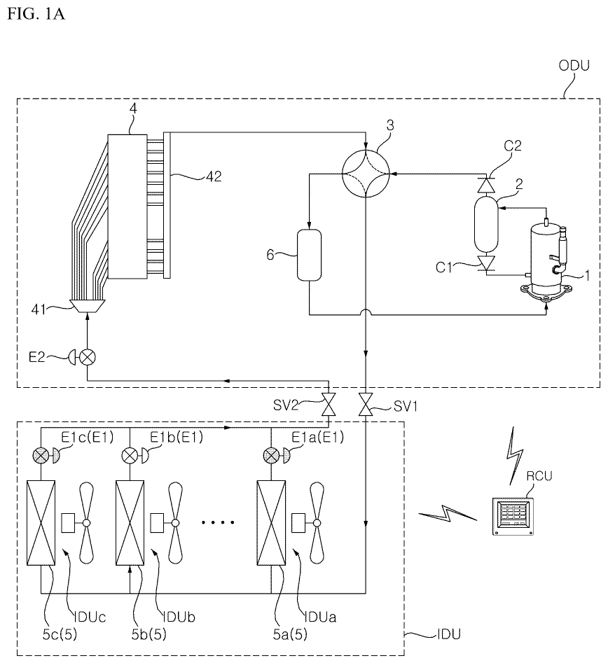

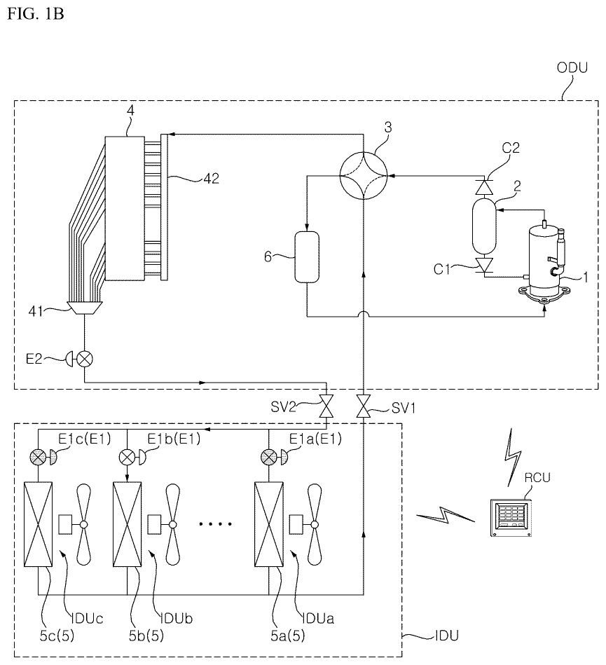

FIG. 1A and FIG. 1B are drawings illustrating a system, according to various embodiments of the present disclosure.

Referring to FIG. 1A and FIG. 1B, the system may include a compressor 1 that compresses a refrigerant. The refrigerant compressed in the compressor 1 may circulate a refrigerant cycle. In this disclosure, it is described that the system is an air conditioner that provides heat-exchanged air to a room based on a refrigerant cycle.

The system may have an outdoor unit (ODU) and an indoor unit (IDU) that are connected to each other by a refrigerant pipe. The system may further have a remote control unit (RCU). The outdoor unit (ODU), the indoor unit (IDU), and/or the remote control unit (RCU) may transmit and receive signals to and from each other.

The outdoor unit (ODU) may have a compressor 1, an oil separator 2, a switching valve 3, an outdoor heat exchanger 4, an outdoor expansion valve E2, and/or an accumulator 6. The indoor unit (IDU) may have an indoor heat exchanger 5 and an indoor expansion valve E1.

The compressor 1 may compress refrigerant flowed in from the accumulator 6 by high temperature and high pressure. For example, the compressor 1 may be an inverter compressor that can control the amount of refrigerant and the discharge pressure of the refrigerant by adjusting an operating frequency. For example, the compressor 1 may be an oil compressor that uses oil as a lubricant.

The oil separator 2 may recover oil from the refrigerant discharged from the compressor 1 and provide it back to the compressor 1. At this time, a first check valve C1 may be installed in a pipe through which the oil separated from the oil separator 2 flows, so as to limit the flow direction of the oil to a direction from the oil separator 2 to the compressor 1.

The switching valve 3 may selectively guide the refrigerant flowed in from the oil separator 2 to the outdoor heat exchanger 4 or the indoor heat exchanger 5. For example, the switching valve 3 may be a four-way valve. At this time, the second check valve C2 may limit the flow direction of the refrigerant to a direction from the oil separator 2 to the switching valve 3.

The outdoor heat exchanger 4 may exchange heat between the refrigerant and the outdoor air. The direction of heat transmission between the refrigerant and the outdoor air in the outdoor heat exchanger 4 may vary depending on the operating mode of the system, i.e., whether it is a heating operation or a cooling operation. An outdoor fan (not shown) is installed in one side of the outdoor heat exchanger 4 and may control the amount of air provided to the outdoor heat exchanger 4.

The indoor heat exchanger 5 may exchange heat between the refrigerant and the indoor air. The direction of heat transmission between the refrigerant and the indoor air in the indoor heat exchanger 5 may vary depending on the operating mode of the system, i.e., whether it is a heating operation or a cooling operation. An indoor fan (not shown) may be installed in one side of the indoor heat exchanger 5 and may control the amount of air provided to the indoor heat exchanger 5.

For example, the indoor heat exchanger 5 may include a plurality of indoor heat exchangers 5a, 5b, 5c. In this case, the indoor unit (IDU) may include a first indoor unit (IDUa) having a first indoor heat exchanger 5a, a first indoor fan, and a first indoor expansion valve E1a, a second indoor unit (IDUb) having a second indoor heat exchanger 5b, a second indoor fan, and a second indoor expansion valve E1b, and a third indoor unit (IDUc) having a third indoor heat exchanger 5c, a third indoor fan, and a third indoor expansion valve E1c. Meanwhile, in response to a required load for indoor cooling or heating, some of a plurality indoor heat exchangers 5a, 5b, 5c may be operated, and the rest may not be operated.

The expansion valve E1, E2 may be installed between the outdoor heat exchanger 4 and the indoor heat exchanger 5, and may expand the refrigerant that has passed through the outdoor heat exchanger 4 or the indoor heat exchanger 5. In addition, the expansion valves E1, E2 may include an outdoor expansion valve E2 adjacent to the outdoor heat exchanger 4 and an indoor expansion valve E1 adjacent to the indoor heat exchanger 5. In this case, the outdoor expansion valve E2 may be used to expand the refrigerant that has passed through the indoor heat exchanger 5, and the indoor expansion valve E1 may be used to expand the refrigerant that has passed through the outdoor heat exchanger 4. For example, the expansion valve E1, E2 may be Electronic Expansion Valve (EEV) capable of controlling the opening degree of the flow path of the refrigerant pipe in which the expansion valve E1, E2 is installed.

For example, the indoor expansion valve E1 may include a first indoor expansion valve E1a that expands the refrigerant provided to the first indoor heat exchanger 5a, a second indoor expansion valve E1b that expands the refrigerant provided to the second indoor heat exchanger 5b, and a third indoor expansion valve E1c that expands the refrigerant provided to the third indoor heat exchanger 5c.

A plurality of sensors (not shown) may measure the temperature and/or pressure of the refrigerant flowing through the refrigerant pipe. A controller (not shown) may be electrically connected to each component of the system, and may control the operation of each component of the system.

Referring to FIG. 1A, when a heating operation signal is input to the system, the controller may perform heating operation of the system. For example, the heating operation signal may be a signal arbitrarily input by a user.

For another example, the heating operation signal may be a signal provided by a thermostat installed in an indoor space to a controller, when the indoor temperature detected by the indoor temperature sensor is lower than a desired temperature set by a user by a certain level or higher.

Specifically, the low-temperature, low-pressure refrigerant flowing from the accumulator 6 to the compressor 1 may be compressed by high temperature, high pressure in the compressor 1 and discharged to the oil separator 2. Then, the refrigerant from which oil is separated in the oil separator 2 may flow into the second indoor heat exchanger 5b via the switching valve 3 and the first service valve SV1. At this time, the second indoor expansion valve E1b may completely open the refrigerant flow path that passes through the second indoor heat exchanger 5b and leads to the outdoor heat exchanger 4. In addition, the first indoor expansion valve E1a and the third indoor expansion valve E1c can close the refrigerant flow path that passes through the first indoor heat exchanger 5a and the third indoor heat exchanger 5c and leads to the outdoor heat exchanger 4. In addition, when a required heating load increases, the first indoor expansion valve E1a and/or the third indoor expansion valve E1c may also be opened.

As heat energy is transmitted from the refrigerant to the indoor air in the second indoor heat exchanger 5b, the refrigerant may be condensed. At this time, the second indoor heat exchanger 5b may serve as a condenser. In addition, as the heat exchange occurs between the refrigerant and the indoor air, the indoor space may be heated. The refrigerant condensed while passing through the second indoor heat exchanger 5b may pass through the outdoor expansion valve E2, via the second indoor expansion valve E1b and a second service valve SV2. The refrigerant expanded while passing through the outdoor expansion valve E2 may be distributed to multiple points of the outdoor heat exchanger 4 via a distributor 41.

As the heat energy of the outdoor air is transmitted to the refrigerant in the outdoor heat exchanger 4, the refrigerant may be evaporated. At this time, the outdoor heat exchanger 4 may serve as an evaporator. The refrigerant evaporated while passing through the outdoor heat exchanger 4 may be flowed into the compressor 1 via the header 42, the switching valve 3, and the accumulator 6 sequentially. Thus, a refrigerant cycle for the heating operation of the aforementioned system can be completed.

Referring to FIG. 1B, when a cooling operation signal is input to the system, the controller may perform the cooling operation of the system. For example, the cooling operation signal may be a signal arbitrarily input by a user.

For another example, the cooling operation signal may be a signal provided by a thermostat installed in the indoor space to the controller, when the indoor temperature detected by the indoor temperature sensor is higher than a desired temperature set by a user by a certain level or higher.

Specifically, the low-temperature, low-pressure refrigerant flowing from the accumulator 6 to the compressor 1 may be compressed by a high temperature, high pressure in the compressor 1 and discharged to the oil separator 2. Then, the refrigerant from which oil is separated in the oil separator 2 may be flowed into the outdoor heat exchanger 4 via the switching valve 3 and the header 42.

As heat energy is transmitted from the refrigerant to the outdoor air in the outdoor heat exchanger 4, the refrigerant may be condensed. At this time, the outdoor heat exchanger 4 may serve as a condenser.

The refrigerant condensed while passing through the outdoor heat exchanger 4 may flow into the second indoor expansion valve E1b via the distributor 41, the outdoor expansion valve E2, and the second service valve SV2 sequentially. At this time, the outdoor expansion valve E2 may completely open the flow path. Then, the refrigerant expanded while passing through the second indoor expansion valve E1b may flow into the second indoor heat exchanger 5b. In addition, when the required cooling load increases, the first indoor expansion valve E1a and/or the third indoor expansion valve E1c may also be opened by a certain degree.

As the heat energy of the indoor air is transmitted to the refrigerant in the second indoor heat exchanger 5b, the refrigerant may evaporate. At this time, the second indoor heat exchanger 5b may serve as an evaporator. Then, the indoor space may be cooled by the heat exchange between the refrigerant and the indoor air. The refrigerant that has evaporated while passing through the second indoor heat exchanger 5b may be flowed into the compressor 1 via the first service valve SV1, the switching valve 3, and the accumulator 6 sequentially. Thus, a refrigerant cycle for cooling operation of the aforementioned system may be completed.

Meanwhile, the system may perform an oil recovery operation. For example, when the system performs an oil recovery operation, the system may control the switching valve 3 so that the refrigerant discharged from the compressor 1 flows to the outdoor heat exchanger 4. At this time, the refrigerant may be condensed by heat exchange between the refrigerant and the outdoor air that occurs in the outdoor heat exchanger 4. The refrigerant condensed in the outdoor heat exchanger 4 may be flowed into the indoor unit (IDU). The refrigerant may be evaporated by heat exchange between the refrigerant flowed into the indoor unit (IDU) and the indoor air.

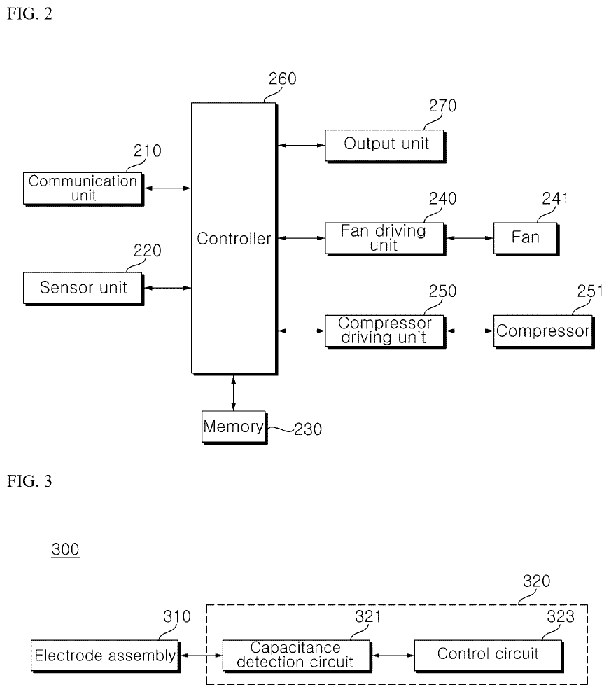

According to an embodiment, when performing an oil recovery operation, the system may increase the operating frequency of the compressor 1 to a certain level or more. For example, when performing an oil recovery operation, the system may set the operating frequency of the compressor 1 to the maximum value. When performing an oil recovery operation, the system may stop the operation of an indoor fan. When performing an oil recovery operation, the system may control the operation of the outdoor fan, based on the pressure of the outdoor unit-side pipe. For example, if the pressure of the outdoor unit-side pipe exceeds a certain standard, the outdoor fan may be operated, and if it is below the certain standard, the operation of the outdoor fan may be stopped. FIG. 2 is a block diagram of a system, according to an embodiment of the present disclosure.

Referring to FIG. 2, the system may include a communication unit 210, a sensor unit 220, a memory 230, a fan driving unit 240 that drives a fan 241, a compressor driving unit 250 that drives a compressor 251 (compressor 1 of FIG. 1A), and/or a controller 260.

The communication unit 210 may include at least one communication module. For example, the communication unit 210 may be provided in each of the outdoor unit (ODU) and the indoor unit (IDU), and the outdoor unit (ODU) and the indoor unit (IDU) may transmit and receive data to and from each other. For example, the communication unit 210 may be provided in the remote control unit (RCU).

The communication method of the outdoor unit (ODU), the indoor unit (IDU), and/or the remote control unit (RCU) may be, for example, a communication method using a power line, a serial communication method (e.g., RS-485 communication), a wired communication method through refrigerant piping, or a wireless communication method such as Wi-fi, Bluetooth, Beacon, and Zigbee.

The communication unit 210 may transmit and receive data to and from an external device. For example, the communication unit 210 may access a server connected to an external network to transmit and receive data.

The sensor unit 220 may have at least one sensor, and may transmit data on a detection value detected through the sensor to the controller 260.

The sensor unit 220 may have a heat exchanger temperature sensor (not shown). For example, the heat exchanger temperature sensor may be arranged inside the indoor heat exchanger 5, and may detect the temperature of the indoor heat exchanger 5.

The sensor unit 220 may have a pipe temperature sensor (not shown). The pipe temperature sensor may detect the temperature of the refrigerant flowing through each pipe of the system. For example, the pipe temperature sensor may be arranged in the inlet-side pipe of the indoor unit (IDU) and/or the outlet-side pipe of the indoor unit (IDU), and may detect the temperature of the refrigerant flowing through the pipe. For example, the pipe temperature sensor may be arranged in a pipe connected to the compressor 251 to detect the temperature (hereinafter, suction temperature) of the refrigerant flowing into the compressor 251 and/or the temperature (hereinafter, discharge temperature) of the refrigerant discharged from the compressor 251.

The sensor unit 210 may have a pressure sensor (not shown). The pressure sensor (not shown) may detect the pressure of the gaseous refrigerant flowing through each pipe of the system. For example, the pressure sensor may be arranged in a pipe connected to the compressor 251 to detect the pressure (hereinafter, suction pressure) of the refrigerant flowing into the compressor 251 and/or the pressure (hereinafter, discharge pressure) of the refrigerant discharged from the compressor 251.

The sensor unit 220 may have an indoor temperature sensor (not shown) that detects the indoor temperature and/or an outdoor temperature sensor (not shown) that detects the outdoor temperature.

The sensor unit 220 may have an indoor humidity sensor (not shown) that detects indoor humidity and/or an outdoor humidity sensor (not shown) that detects outdoor humidity.

The sensor unit 220 may include a sensor 300 (see FIG. 3) (hereinafter, oil sensor) that outputs a signal corresponding to oil stored inside the compressor 251. The oil sensor 300 may detect the amount of fluid stored inside the compressor 251. The oil sensor 300 may detect the concentration of oil with respect to the fluid. The fluid stored inside the compressor 251 may at least include oil. The fluid stored inside the compressor 251 may further include a refrigerant.

The memory 230 may store data related to the operation of each component provided in the system.

The memory 230 may store programs for processing and controlling each signal within the controller 260, and may store processed data and data to be processed. For example, the memory 230 may store application programs designed for the purpose of performing various tasks that can be processed by the controller 260, and may selectively provide some of the stored application programs when requested by the controller 260.

The memory 230 may include, for example, at least one of volatile memory (e.g., DRAM, SRAM, SDRAM, etc.) and nonvolatile memory (e.g., flash memory, hard disk drive (HDD), solid-state drive (SSD), etc.).

The fan driving unit 240 may drive the fan 241 provided in the system. For example, the fan 241 may include an outdoor fan and/or an indoor fan.

The fan driving unit 240 may include a rectifier (not shown) that rectifies AC power into DC power and outputs it, a DC-link capacitor (not shown) that stores a pulsating voltage from the rectifier, an inverter (not shown) that has a plurality of switching elements and converts and outputs smoothed DC power into three-phase AC power of a certain frequency, and/or at least one motor that drives the fan 241 according to the three-phase AC power output from the inverter.

Meanwhile, the fan driving unit 240 may be provided with separate configurations for driving the outdoor fan and the indoor fan, respectively. For example, the system may include a first fan driving unit for driving the outdoor fan and a second fan driving unit for driving the indoor fan.

The compressor driving unit 250 may drive the compressor 251. The compressor driving unit 250 may include a rectifier (not shown) that rectifies AC power into DC power and outputs it, a DC-link capacitor (not shown) that stores a pulsating voltage from the rectifier, an inverter (not shown) that has a plurality of switching elements, and converts and outputs smoothed DC power into three-phase AC power of a certain frequency, and/or a compressor motor 102b that drives the compressor 251 according to the three-phase AC power output from the inverter.

The controller 260 may control the overall operation of the system. The controller 260 may be connected to each component provided in the system, and may control the overall operation of each component by transmitting and/or receiving signals to/and from each component.

The controller 260 may control the operation of the fan driving unit 240 and change the rotation speed of the fan 241. For example, the fan driving unit 240 may change the rotation speed of the outdoor fan by changing the frequency of the three-phase AC power output to the outdoor fan motor, according to the control of the controller 260. For example, the fan driving unit 240 may change the rotation speed of the indoor fan by changing the frequency of the three-phase AC power output to the indoor fan motor, according to the control of the controller 260.

The controller 260 may control the operation of the compressor driving unit 250 to change the operating frequency of the compressor 251. For example, the compressor driving unit 250 may change the operating frequency of the compressor 251, by changing the frequency of the three-phase AC power output to the compressor motor 102b, according to the control of the controller 260.

The controller 260 may be equipped not only in the outdoor unit (ODU), but also in the indoor unit (IDU), the outdoor unit (ODU), and/or the remote control unit (RCU).

The controller 260 may include at least one processor, and may control the overall operation of the system by using the processor included therein. Here, the processor may be a general processor such as a central processing unit (CPU). Obviously, the processor may be a dedicated device such as an ASIC or another hardware-based processor.

The controller 260 may obtain data related to each component provided in the system. At this time, the controller 260 may obtain data related to each component provided in the system at regular time intervals, according to a certain cycle, in consideration of a computational load.

The controller 260 may perform various computations based on the acquired data, and may control the overall operation of each component provided in the system according to a computational result.

Data related to each component provided in the system may include, for example, the operating frequency of the compressor 251, the suction temperature of the compressor 251, the discharge temperature, the suction pressure, the discharge pressure, the concentration of oil stored inside the compressor 251, the amount of oil, the inlet-side pipe temperature of the indoor unit (IDU), the outlet-side pipe temperature of the indoor unit (IDU), the indoor temperature, the outdoor temperature, the opening amount of the electronic expansion valve (EEV), etc.

Meanwhile, the system may further include an input device (not shown) capable of receiving an user input. For example, when the system receives a user input through an input device (e.g., a touch panel, a key, etc.) the system may perform an operation corresponding to the received user input.

The system may further include an output device (not shown) that outputs a message related to the operating state of the system. For example, the output device may include a display device such as a display and a light emitting diode LED and/or an audio device such as a speaker and a buzzer.

FIG. 3 is a block diagram of a sensor, according to an embodiment of the present disclosure.

Referring to FIG. 3, the oil sensor 300 may include an electrode assembly 310 and/or a processing circuit 320.

The electrode assembly 310 may include a plurality of electrodes. Some of the plurality of electrodes included in the electrode assembly 310 may be formed to extend vertically. Others of the plurality of electrodes included in the electrode assembly 310 may be formed to extend horizontally.

The electrode assembly 310 may be disposed inside the compressor 1. The electrode assembly 310 may be exposed to a fluid stored inside the compressor 1. At least some of the plurality of electrodes included in the electrode assembly 310 may be arranged to be immersed in the fluid. The fluid stored inside the compressor 1 may at least include oil. The fluid stored inside the compressor 1 may further include a refrigerant.

A voltage may be applied to the electrode assembly 310. A sensing voltage may be applied to some of the plurality of electrodes included in the electrode assembly 310. The sensing voltage may be an AC voltage whose voltage value changes periodically. The sensing voltage may have a certain frequency. A ground voltage may be applied to others of the plurality of electrodes included in the electrode assembly 310.

The processing circuit 320 may be electrically connected to the electrode assembly 310. The processing circuit 320 may apply a voltage to the electrode assembly 310.

The processing circuit 320 may detect capacitance, based on the voltage applied to the electrode assembly 310. The processing circuit 320 may detect capacitance corresponding to a first electrode to which a sensing voltage is applied and a second electrode to which a ground voltage is applied, among a plurality of electrodes included in the electrode assembly 310. The capacitance corresponding to two electrodes among the plurality of electrodes may be detected based on Equation 1.

$$i . C = {ε}_{0} {ε}_{r} \frac{A}{d} \qquad [ Equation 1 ]$$

Here, C may mean capacitance, co may mean permittivity corresponding to vacuum, Er may mean relative permittivity corresponding to a material between two electrodes, d may mean a distance between two electrodes, and A may mean an area of an electrode in contact with a material.

The processing circuit 320 may calculate the concentration of oil contained in the fluid stored inside the compressor 1, based on the capacitance for the electrode assembly 310. The processing circuit 320 may calculate the amount of fluid stored inside the compressor 1, based on the capacitance for the electrode assembly 310.

The processing circuit 320 may include a capacitance detection circuit 321 that detects the capacitance for the electrode assembly 310. The processing circuit 320 may include a control circuit 323 that calculates the concentration of oil and the amount of fluid. The capacitance detection circuit 321 and the control circuit 323 may be implemented as one configuration or may be implemented as separate configurations.

Meanwhile, the capacitance detection circuit 321 and/or the control circuit 323 may be included in the controller 260 of the system.

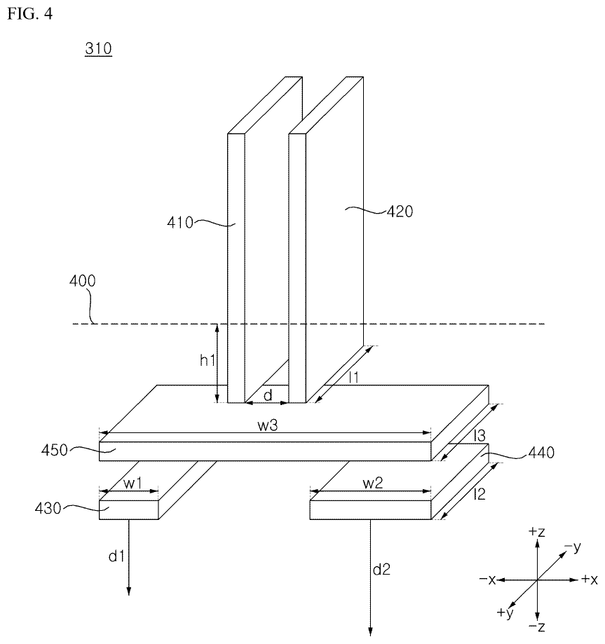

FIG. 4 is a drawing illustrating a configuration of an electrode assembly, according to an embodiment of the present disclosure.

Referring to FIG. 4, the electrode assembly 310 may include a plurality of vertical electrodes 410, 420.

The plurality of vertical electrodes 410, 420 may be formed to extend vertically. The plurality of vertical electrodes 410, 420 may be formed to have a first length 11 along the front-rear direction.

The plurality of vertical electrodes 410, 420 may be arranged to face each other. One surface of a first vertical electrode 410 and one surface of a second vertical electrode 420 may face each other. The plurality of vertical electrodes 410, 420 may be arranged in parallel.

The plurality of vertical electrodes 410, 420 may be arranged to be spaced apart from each other by a certain distance d. One surface of the first vertical electrode 410 and one surface of the second vertical electrode 420 that face each other may be spaced apart by a certain distance d.

At least some of the plurality of vertical electrodes 410, 420 may come into contact with the fluid stored inside the compressor 1. A sensing voltage may be applied to the first vertical electrode 410. A ground voltage may be applied to the second vertical electrode 420.

Since the distance d between the plurality of vertical electrodes 410, 420 and the length 11 of the plurality of vertical electrodes 410, 420 are constant, the capacitance corresponding to the plurality of vertical electrodes 410, 420 may correspond to the height h1 (hereinafter, fluid level height) from the bottom of the plurality of vertical electrodes 410, 420 to the surface 400 of the fluid. That is, the capacitance corresponding to the plurality of vertical electrodes 410, 420 may correspond to the amount of fluid stored inside the compressor 251.

Meanwhile, the capacitance corresponding to the plurality of vertical electrodes 410, 420 may correspond to the concentration of oil contained in the fluid located between the plurality of vertical electrodes 410, 420.

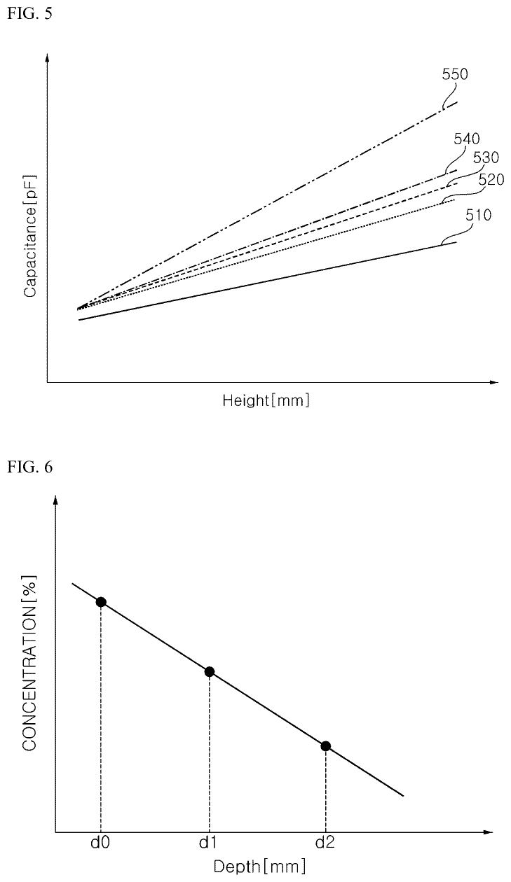

Referring to FIG. 5, as the oil surface height h1 increases, the capacitance corresponding to the plurality of vertical electrodes 410, 420 may increase. At this time, the capacitance corresponding to the plurality of vertical electrodes 410, 420 may vary depending on the concentration of oil contained in the fluid.

For example, when comparing a case 510 where the oil concentration is 100%, a case 520 where the oil concentration is 75%, a case 530 where the oil concentration is 50%, a case 540 where the oil concentration is 33%, and a case 550 where the oil concentration is 0% with each other, as the oil concentration may become higher, the change in the capacitance corresponding to the plurality of vertical electrodes 410, 420 according to the oil surface height h1 may become smaller.

Therefore, since the capacitance corresponding to the plurality of vertical electrodes 410, 420 varies depending on the oil concentration, the control circuit 323 may first determine the oil concentration and then determine the amount of fluid based on the oil concentration.

Referring again to FIG. 4, the electrode assembly 310 may include a first horizontal electrode 430 and/or a second horizontal electrode 440.

The first horizontal electrode 430 may be formed to extend horizontally. The first horizontal electrode 430 may be formed to have a first width w1 along the left-right direction. The first horizontal electrode 430 may be formed to have a second length 12 along the front-rear direction.

The first horizontal electrode 430 may be arranged below the plurality of vertical electrodes 410, 420. The first horizontal electrode 430 may be arranged to be immersed in the fluid stored inside the compressor 1. That is, in the case where a minimum amount of fluid is stored inside the compressor 1, the surface 400 of the fluid may be located above the first horizontal electrode 430.

The second horizontal electrode 440 may be formed to extend horizontally. The second horizontal electrode 440 may be formed to have a second width w2 that is different from the first width w1. In this disclosure, it is illustrated that the first width w1 is smaller than the second width w2. The second horizontal electrode 440 may be formed to have a second length 12 along the front-rear direction.

The second horizontal electrode 440 may be arranged below the plurality of vertical electrodes 410, 420. The second horizontal electrode 440 may be arranged to be immersed in the fluid stored inside the compressor 1. That is, in the case where a minimum amount of fluid is stored inside the compressor 1, the surface 400 of the fluid may be located above the second horizontal electrode 440.

The first horizontal electrode 430 and the second horizontal electrode 440 may be arranged in parallel along the horizontal direction. The first horizontal electrode 430 and the second horizontal electrode 440 may be arranged spaced apart from each other.

The electrode assembly 310 may include a shield electrode 450. The shield electrode 450 may be formed to extend horizontally. The shield electrode 450 may be formed to have a third width w3. The third width w3 may be greater than or equal to the sum of the first width w1 and the second width w2. The shield electrode 450 may be formed to have a third length 13 along the front-rear direction. The third length 13 may be greater than or equal to a second length 12. In the present disclosure, it is described that both ends of the shield electrode 450 correspond to the first horizontal electrode 430 and the second horizontal electrode 440, respectively, but is not limited thereto. For example, the left end of the shield electrode 450 may extend away from the first horizontal electrode 430. For example, the right end of the shield electrode 450 may extend away from the second horizontal electrode 440.

The shield electrode 450 may be arranged below the plurality of vertical electrodes 410, 420. The shield electrode 450 may be arranged so as to cover the first horizontal electrode 430 from the upper side. The shield electrode 450 may be arranged so as to cover the second horizontal electrode 440 from the upper side.

As the shield electrode 450 is arranged above the first horizontal electrode 430 so as to cover the first horizontal electrode 430, the influence of the second vertical electrode 420 on the first horizontal electrode 430 may be reduced. In addition, as the shield electrode 450 is arranged above the second horizontal electrode 440 so as to cover the second horizontal electrode 440, the influence of the second vertical electrode 420 on the second horizontal electrode 440 may be reduced.

Meanwhile, as the shield electrode 450 is arranged above the first horizontal electrode 430 so as to cover the first horizontal electrode 430, the influence of the change in the fluid level height h1 according to the amount of fluid on the capacitance corresponding to the first horizontal electrode 430 and the shield electrode 450 may be reduced.

In addition, as the shield electrode 450 is arranged above the second horizontal electrode 440 so as to cover the second horizontal electrode 440, the influence of the change in the fluid level height h1 according to the amount of fluid on the capacitance corresponding to the second horizontal electrode 440 and the shield electrode 450 may be reduced.

The shield electrode 450 may be arranged so that at least a portion of the shield electrode 450 is immersed in the fluid stored inside the compressor 1. In the case where a minimum amount of fluid is stored inside the compressor 1, the surface 400 of the fluid may be located above the lower surface of the shield electrode 450. That is, the shield electrode 450 may be arranged so that the lower surface of the shield electrode 450 is immersed in the fluid stored inside the compressor 1.

A sensing voltage may be applied to the first horizontal electrode 430. A sensing voltage may be applied to the second horizontal electrode 440. A ground voltage may be applied to the shield electrode 450.

Since the lower surfaces of the first horizontal electrode 430 and the shield electrode 450 are immersed in the fluid, the capacitance corresponding to the first horizontal electrode 430 and the shield electrode 450 may correspond to the concentration of oil contained in the fluid. Since the lower surfaces of the second horizontal electrode 440 and the shield electrode 450 are immersed in the fluid, the capacitance corresponding to the second horizontal electrode 440 and the shield electrode 450 may correspond to the concentration of oil contained in the fluid.

The capacitance corresponding to the first horizontal electrode 430 and the shield electrode 450 may correspond to the oil concentration for a first depth d1 of the fluid facing downward. The capacitance corresponding to the second horizontal electrode 440 and the shield electrode 450 may correspond to the oil concentration for a second depth d2 of the fluid facing downward. At this time, since the first width w1 of the first horizontal electrode 430 and the second width w2 of the second horizontal electrode 440 are different, the first depth d1 and the second depth d2 may be different from each other. Since the first width w1 is smaller than the second width w2, the first depth d1 may be smaller than the second depth d2.

According to an embodiment, the control circuit 323 may determine the oil concentration corresponding to the depth of the fluid. For example, the control circuit 323 may determine the oil concentration corresponding to the first depth d1 of the fluid, based on the capacitance corresponding to the first horizontal electrode 430 and the shield electrode 450. For example, the control circuit 323 may determine the oil concentration corresponding to the second depth d2 of the fluid, based on the capacitance corresponding to the second horizontal electrode 440 and the shield electrode 450.

Referring to FIG. 6, when the first concentration of oil corresponding to the first depth d1 of the fluid and the second concentration of oil corresponding to the second depth d2 of the fluid are different from each other, the control circuit 323 may determine the concentration of oil corresponding to the surface do of the fluid, based on the first concentration of oil and the second concentration of oil. For example, the control circuit 323 may determine the concentration of oil corresponding to the surface do of the fluid, based on the difference between the first concentration and the second concentration, for the difference between the first depth d1 and the second depth d2. For example, the control circuit 323 may determine the concentration of oil corresponding to the surface d0 of the fluid, based on the data related to the concentration of oil corresponding to the surface do of the fluid, corresponding to the first concentration, the second concentration, and the difference between the first concentration and the second concentration.

Therefore, according to various embodiments of the present disclosure, the control circuit 323 may first determine the concentration of oil, and then determine the amount of fluid based on the concentration of oil. For example, the control circuit 323 may determine the concentration of oil, based on the capacitance corresponding to the first horizontal electrode 430 and the shield electrode 450, and then determine the amount of fluid based on the determined concentration of oil. For example, the control circuit 323 may determine the concentration of oil, based on the capacitance corresponding to the second horizontal electrode 440 and the shield electrode 450, and then determine the amount of fluid based on the determined concentration of oil. For example, the control circuit 323 may determine the concentration of oil corresponding to the surface do of the fluid, based on the capacitance corresponding to the first horizontal electrode 430 and the shield electrode 450 and the capacitance corresponding to the second horizontal electrode 440 and the shield electrode 450, and then determine the amount of fluid based on the determined concentration of oil.

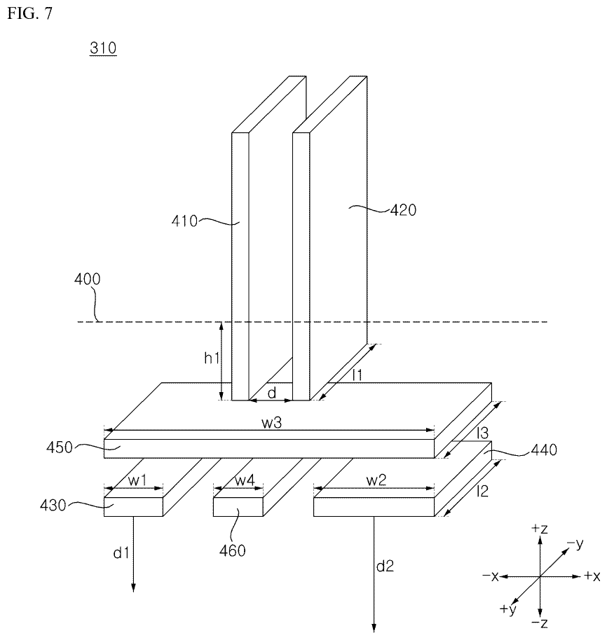

FIG. 7 is a drawing illustrating the configuration of an electrode assembly, according to another embodiment of the present disclosure. Detailed descriptions of contents overlapping with those described in FIG. 4 will be omitted.

Referring to FIG. 7, the electrode assembly 310 may further include a ground electrode 460. The ground electrode 460 may be formed to extend horizontally. The ground electrode 460 may be formed to have a fourth width w4 along the left-right direction. The ground electrode 460 may be formed to have a second length 12 along the front-rear direction.

The ground electrode 460 may be arranged below the plurality of vertical electrodes 410, 420. The ground electrode 460 may be arranged below the shield electrode 450. The ground electrode 460 may be arranged to be covered by the shield electrode 450. The ground electrode 460 may be arranged to be immersed in the fluid stored inside the compressor 1. That is, in the case where a minimum amount of fluid is stored inside the compressor 1, the surface 400 of the fluid may be located above the ground electrode 460.

The first horizontal electrode 430, the second horizontal electrode 440, and the ground electrode 460 may be arranged in parallel along the horizontal direction. The first horizontal electrode 430, the second horizontal electrode 440, and the ground electrode 460 may be arranged spaced apart from each other. The ground electrode 460 may be arranged between the first horizontal electrode 430 and the second horizontal electrode 440.

A sensing voltage may be applied to the first horizontal electrode 430. A sensing voltage may be applied to the second horizontal electrode 440. A ground voltage may be applied to the ground electrode 460.

Since the first horizontal electrode 430 and the ground electrode 460 are immersed in the fluid, the capacitance corresponding to the first horizontal electrode 430 and the ground electrode 460 may correspond to the concentration of oil contained in the fluid.

Since the second horizontal electrode 440 and the ground electrode 460 are immersed in the fluid, the capacitance corresponding to the second horizontal electrode 440 and the ground electrode 460 may correspond to the concentration of oil contained in the fluid.

The capacitance corresponding to the first horizontal electrode 430 and the ground electrode 460 may correspond to the concentration of oil for a third depth d3 of the fluid facing downward. The capacitance corresponding to the second horizontal electrode 440 and the ground electrode 460 may correspond to the concentration of oil for a fourth depth d4 of the fluid facing downward. At this time, since the first width w1 of the first horizontal electrode 430 and the second width w2 of the second horizontal electrode 440 are different, the third depth d3 and the fourth depth d4 may be different from each other. Since the first width w1 is smaller than the second width w2, the third depth d3 may be smaller than the fourth depth d4.

According to an embodiment, the control circuit 323 may determine the concentration of oil corresponding to the depth of the fluid.

For example, the control circuit 323 may determine the concentration of oil corresponding to the third depth d3 of the fluid, based on the capacitance corresponding to the first horizontal electrode 430 and the ground electrode 460.

For example, the control circuit 323 may determine the concentration of oil corresponding to the fourth depth d4 of the fluid, based on the capacitance corresponding to the second horizontal electrode 440 and the ground electrode 460.

When the third concentration of oil corresponding to the third depth d3 of the fluid and the fourth concentration of oil corresponding to the fourth depth d4 of the fluid are different from each other, the control circuit 323 may determine the concentration of oil corresponding to the surface do of the fluid, based on the third concentration of oil and the fourth concentration of oil.

Therefore, according to various embodiments of the present disclosure, the control circuit 323 may first determine the concentration of oil, and then determine the amount of fluid based on the concentration of oil. For example, the control circuit 323 may determine the concentration of oil based on the capacitance corresponding to the first horizontal electrode 430 and the ground electrode 460, and then determine the amount of fluid based on the determined concentration of oil. For example, the control circuit 323 may determine the concentration of oil based on the capacitance corresponding to the second horizontal electrode 440 and the ground electrode 460, and then determine the amount of fluid based on the determined concentration of oil. For example, the control circuit 323 may determine the concentration of oil corresponding to the surface do of the fluid based on the capacitance corresponding to the first horizontal electrode 430 and the ground electrode 460 and the capacitance corresponding to the second horizontal electrode 440 and the ground electrode 460, and then determine the amount of the fluid based on the determined oil concentration.

According to an embodiment, no voltage may be applied to the shield electrode 450. That is, the shield electrode 450 may be configured for passive shielding. If the shield electrode 450 is configured for passive shielding, the influence of the second vertical electrode 420 on the first horizontal electrode 430 and/or the second horizontal electrode 440 may be further reduced. In addition, when the shield electrode 450 is configured for passive shielding, the influence of the change in the fluid level height h1 according to the amount of fluid on the capacitance corresponding to the first horizontal electrode 430 and the ground electrode 460 and/or the capacitance corresponding to the second horizontal electrode 440 and the ground electrode 460 may be further reduced. In addition, when the shield electrode 450 is configured for passive shielding, the electrode assembly 310 may block the influence of noise coming in from the outside.

Meanwhile, when the shield electrode 450 is configured for passive shielding, parasitic capacitance may exist between the first horizontal electrode 430 and the shield electrode 450. In addition, parasitic capacitance may also exist between the second horizontal electrode 440 and the shield electrode 450. Such a parasitic capacitance may be a factor that reduces a signal-to-noise ratio (SNR).

According to an embodiment, a sensing voltage may be applied to the shield electrode 450. That is, the shield electrode 450 may be configured for active shielding.

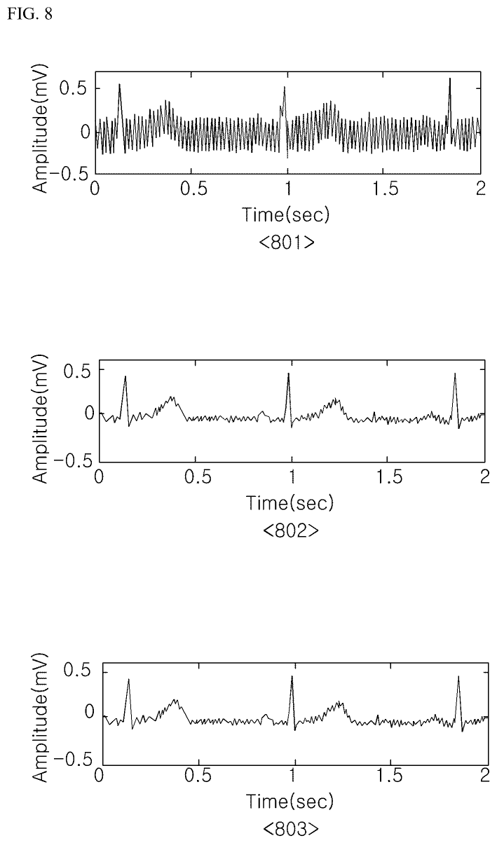

Referring to FIG. 8, when reviewing the output of the sensor in a time domain, in case 802 there is a configuration for passive shielding, or in case 803 there is a configuration for active shielding, the noise included in the output of the sensor may be significantly reduced, in comparison with a case 801 where there is no configuration for passive shielding or active shielding 801.

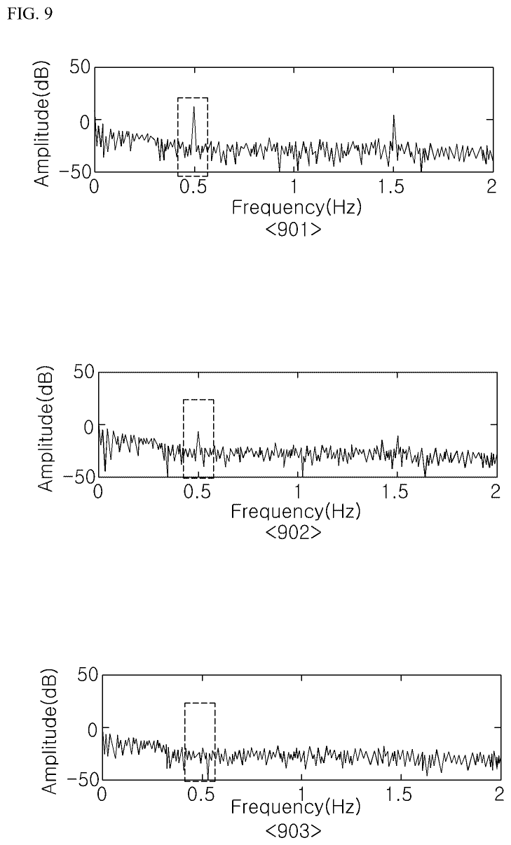

Meanwhile, referring to FIG. 9, when reviewing the output of the sensor in a frequency domain, in case 902 there is a configuration for passive shielding, the noise peak at a certain frequency (e.g., 50 Hz) may be reduced, in comparison with a case 801 where there is no configuration for passive shielding or active shielding.

In addition, in case 903 there is a configuration for active shielding, the noise peak at a certain frequency (e.g., 50 Hz) may be further reduced, in comparison with a case 902 where there is a configuration for passive shielding.

Thus, when a sensing voltage is applied to the shield electrode 450, no potential difference occurs between the first horizontal electrode 430 and the shield electrode 450 and between the second horizontal electrode 440 and the shield electrode 450, so that the parasitic capacitance can be removed. Therefore, due to the removal of the parasitic capacitance, the signal-to-noise ratio (SNR) can be improved.

As described above, according to at least one embodiment of the present disclosure, the concentration of oil existing inside the compressor 1 can be accurately detected.

In addition, according to at least one embodiment of the present disclosure, the amount of oil can be accurately detected based on the concentration of oil existing inside the compressor 1.

Referring to FIGS. 1 to 9, a sensor 300 according to an aspect of the present disclosure includes a plurality of vertical electrodes 410, 420 which are extended vertically and arranged to face each other; a first horizontal electrode 430 arranged on a lower side of the plurality of vertical electrodes 410, 420; and a shield electrode 450 arranged on the lower side of the plurality of vertical electrodes 410, 420 so as to cover the first horizontal electrode 430 from an upper side, in which the first horizontal electrode 430 and the shield electrode 450 are arranged to be immersed in a fluid that at least contains oil, a sensing voltage is applied to a first vertical electrode 410 and the first horizontal electrode 430, and a ground voltage is applied to a second vertical electrode 420 and the shield electrode 450.

In addition, the sensor 300 according to an aspect of the present disclosure further includes a capacitance detection circuit 321 which detects a first capacitance corresponding to the first vertical electrode 410 and the second vertical electrode 420, and a second capacitance corresponding to the first horizontal electrode 430 and the shield electrode 450.

In addition, the sensor 300 according to an aspect of the present disclosure further includes a control circuit 323, and the control circuit 323 determines a concentration of the oil, based on the second capacitance, and determines an amount of the fluid, based on the concentration of the oil and the first capacitance.

In addition, the sensor 300 according to an aspect of the present disclosure further includes a second horizontal electrode 440 arranged below the shield electrode 450, in which the sensing voltage is applied to the second horizontal electrode 440, and a first width w1 of the first horizontal electrode 430 is different from a second width w2 of the second horizontal electrode 440.

In addition, according to an aspect of the present disclosure, the shield electrode 450 is arranged to cover the second horizontal electrode 440 from an upper side.

In addition, according to an aspect of the present disclosure, the first horizontal electrode 430 and the second horizontal electrode 440 are arranged in parallel along a horizontal direction.

In addition, the sensor 300 according to an aspect of the present disclosure further includes a control circuit 323, and the capacitance detection circuit 321 detects a third capacitance corresponding to the second horizontal electrode 440 and the shield electrode 450, in which the control circuit 323 determines a first concentration of the oil corresponding to a first depth of the fluid, based on the second capacitance, determines a second concentration of the oil corresponding to a second depth of the fluid, based on the third capacitance, determines a third concentration of the oil corresponding to a surface of the fluid, based on the first concentration of the oil and the second concentration of the oil, and determines an amount of the fluid, based on the third concentration of the oil and the first capacitance.

A sensor 300 according to another aspect of the present disclosure includes a plurality of vertical electrodes 410, 420 which are extended vertically and arranged to face each other; a first horizontal electrode 430 arranged on a lower side of the plurality of vertical electrodes 410, 420; a ground electrode 460 arranged on a lower side of the plurality of vertical electrodes 410, 420; and a shield electrode 450 arranged on the lower side of the plurality of vertical electrodes 410, 420 so as to cover the first horizontal electrode 430 and the ground electrode 460 from an upper side, in which the shield electrode 450, the first horizontal electrode 430, and the ground electrode 460 are arranged to be immersed in a fluid that at least contains oil, a sensing voltage is applied to a first vertical electrode 410 and the first horizontal electrode 430, and a ground voltage is applied to a second vertical electrode 420 and the ground electrode 460.

In addition, according to an aspect of the present disclosure, the sensing voltage is applied to the shield electrode 450.

In addition, the sensor 300 according to an aspect of the present disclosure further includes a capacitance detection circuit 321 which detects a first capacitance corresponding to the first vertical electrode 410 and the second vertical electrode 420, and a second capacitance corresponding to the first horizontal electrode 430 and the ground electrode 460.

In addition, the sensor 300 according to an aspect of the present disclosure further includes a control circuit 323, in which the control circuit 323 determines a concentration of the oil, based on the second capacitance, and determines an amount of the fluid, based on the concentration of the oil and the first capacitance.

In addition, the sensor 300 according to an aspect of the present disclosure further includes a second horizontal electrode 440 arranged below the shield electrode 450, in which the sensing voltage is applied to the second horizontal electrode 440, and a first width w1 of the first horizontal electrode 430 is different from a second width w2 of the second horizontal electrode 440.

In addition, according to an aspect of the present disclosure, the shield electrode 450 is arranged to cover the second horizontal electrode 440 from an upper side.

In addition, according to an aspect of the present disclosure, the first horizontal electrode 430, the second horizontal electrode 440, and the ground electrode 460 are arranged in parallel along a horizontal direction, and the ground electrode 460 is arranged between the first horizontal electrode 430 and the second horizontal electrode 440.

In addition, the sensor 300 according to an aspect of the present disclosure further includes a control circuit 323, and the capacitance detection circuit 321 detects a third capacitance corresponding to the second horizontal electrode 440 and the ground electrode 460, in which the control circuit 323 determines a first concentration of the oil corresponding to a first depth of the fluid, based on the second capacitance, determines a second concentration of the oil corresponding to a second depth of the fluid, based on the third capacitance, determines a third concentration of the oil corresponding to a surface of the fluid, based on the first concentration of the oil and the second concentration of the oil, and determines an amount of the fluid, based on the third concentration of the oil and the first capacitance.

Since the accompanying drawings are merely for easily understanding embodiments disclosed herein, it should be understood that the technical idea disclosed herein is not limited by the accompanying drawings, and all changes, equivalents or substitutions are included in the idea and technical scope of the present disclosure.

Meanwhile, an operation method of the present disclosure can also be embodied as processor readable code on a processor-readable recording medium. The processor-readable recording medium includes all kinds of recording apparatuses storing data that can be read by a processor. Examples of the processor-readable recording medium is ROM, RAM, CD-ROM, magnetic tapes, floppy disks, optical data storage apparatuses, and, including those that are implemented in the form of carrier waves such as data transmission through the Internet. In addition, the processor-readable recording medium is dispersed in computer systems connected through a network, so that the processor-readable code can be stored and executed in a distributed fashion.

While the present disclosure has been particularly shown and described with reference to exemplary embodiments thereof, it will be understood by those of ordinary skill in the art that various changes in form and detail may be made herein without departing from the idea and scope of the present disclosure as defined by the following claims and such modifications and variations should not be understood individually from the technical idea or aspect of the present disclosure.

What is claimed is:

1. A sensor comprising:
a plurality of vertical electrodes which are extended vertically and arranged to face each other;
a first horizontal electrode arranged on a lower side of the plurality of vertical electrodes; and
a shield electrode arranged on the lower side of the plurality of vertical electrodes so as to cover the first horizontal electrode from an upper side,
wherein the first horizontal electrode and the shield electrode are arranged to be immersed in a fluid that at least contains oil,
wherein a sensing voltage is applied to a first vertical electrode and the first horizontal electrode, and
wherein a ground voltage is applied to a second vertical electrode and the shield electrode.

2. The sensor of claim 1, further comprising a capacitance detection circuit configured to detect a first capacitance corresponding to the first vertical electrode and the second vertical electrode, and a second capacitance corresponding to the first horizontal electrode and the shield electrode.

3. The sensor of claim 2, further comprising a control circuit configured to:
determine a concentration of the oil, based on the second capacitance, and
determine an amount of the fluid, based on the concentration of the oil and the first capacitance.

4. The sensor of claim 2, further comprising a second horizontal electrode arranged below the shield electrode,
wherein the sensing voltage is applied to the second horizontal electrode, and
wherein a first width of the first horizontal electrode is different from a second width of the second horizontal electrode.

5. The sensor of claim 4, wherein the shield electrode is arranged to cover the second horizontal electrode from an upper side.

6. The sensor of claim 4, wherein the first horizontal electrode and the second horizontal electrode are arranged in parallel along a horizontal direction.

7. The sensor of claim 4, further comprising a control circuit,
wherein the capacitance detection circuit is configured to detect a third capacitance corresponding to the second horizontal electrode and the shield electrode, and
wherein the control circuit is configured to:
determine a first concentration of the oil corresponding to a first depth of the fluid, based on the second capacitance,
determine a second concentration of the oil corresponding to a second depth of the fluid, based on the third capacitance,
determine a third concentration of the oil corresponding to a surface of the fluid, based on the first concentration of the oil and the second concentration of the oil, and
determine an amount of the fluid, based on the third concentration of the oil and the first capacitance.

8. A sensor comprising:
a plurality of vertical electrodes which are extended vertically and arranged to face each other;
a first horizontal electrode arranged on a lower side of the plurality of vertical electrodes;
a ground electrode arranged on a lower side of the plurality of vertical electrodes; and
a shield electrode arranged on the lower side of the plurality of vertical electrodes so as to cover the first horizontal electrode and the ground electrode from an upper side,
wherein the shield electrode, the first horizontal electrode, and the ground electrode are arranged to be immersed in a fluid that at least contains oil,
wherein a sensing voltage is applied to a first vertical electrode and the first horizontal electrode, and
wherein a ground voltage is applied to a second vertical electrode and the ground electrode.

9. The sensor of claim 8, wherein the sensing voltage is applied to the shield electrode.

10. The sensor of claim 8, further comprising a capacitance detection circuit configured to detect a first capacitance corresponding to the first vertical electrode and the second vertical electrode, and a second capacitance corresponding to the first horizontal electrode and the ground electrode.

11. The sensor of claim 10, further comprising a control circuit configured to:
determine a concentration of the oil, based on the second capacitance, and
determine an amount of the fluid, based on the concentration of the oil and the first capacitance.

12. The sensor of claim 10, further comprising a second horizontal electrode arranged below the shield electrode,
wherein the sensing voltage is applied to the second horizontal electrode, and a first width of the first horizontal electrode is different from a second width of the second horizontal electrode.

13. The sensor of claim 12, wherein the shield electrode is arranged to cover the second horizontal electrode from an upper side.

14. The sensor of claim 12, wherein the first horizontal electrode, the second horizontal electrode, and the ground electrode are arranged in parallel along a horizontal direction, and
the ground electrode is arranged between the first horizontal electrode and the second horizontal electrode.

15. The sensor of claim 12, further comprising a control circuit,
wherein the capacitance detection circuit is configured to detect a third capacitance corresponding to the second horizontal electrode and the ground electrode, and
wherein the control circuit is configured to:
determine a first concentration of the oil corresponding to a first depth of the fluid, based on the second capacitance,
determine a second concentration of the oil corresponding to a second depth of the fluid, based on the third capacitance,
determine a third concentration of the oil corresponding to a surface of the fluid, based on the first concentration of the oil and the second concentration of the oil, and
determine an amount of the fluid, based on the third concentration of the oil and the first capacitance.
